(19) United States
(12) Patent Application Publication
(10) Pub. No.: US 2015/0278677 A1
(43) Pub. Date: Oct. 1, 2015

(54) Systems, Devices And Methods For Using Massive Data Streams To Emulate Human Response

(71) Applicants: Gary Stephen SHUSTER, Fresno, CA (US); Brian Mark SHUSTER, Vancouver (CA); Charles Marion CURRY, Fresno, CA (US)

(72) Inventors: Gary Stephen SHUSTER, Fresno, CA (US); Brian Mark SHUSTER, Vancouver (CA); Charles Marion CURRY, Fresno, CA (US)

(21) Appl. No.: 14/675,522

(22) Filed: Mar. 31, 2015

Related U.S. Application Data
(60) Provisional application No. 61/973,243, filed on Mar. 31, 2014.

(51) Int. Cl. G06N 3/00; G06N 5/04; G06N 99/00

(52) U.S. Cl. CPC G06N 3/006; G06N 99/005; G06N 5/04

(57) ABSTRACT

Systems, devices and methods for gathering, identifying, analyzing, storing and/or using massive data streams to create a virtual consciousness of a person so as to emulate the person's responses to queries from other people and/or situations after the person is no longer able to communicate are disclosed. The systems, methods and devices determine the appropriate weight to give certain subsets of data based on ambient data and/or sensor data, direct input from the person, media and/or social media, and/or constant feedback throughout the person's remaining life, and utilize computer learning techniques to learn the person's idiosyncrasies, experiences, ethics and morals, attitude, personas, communication preferences, habits, goals, aspirations, beliefs, culture, and other aspects of the person's consciousness to predict the response of the person to the queries and/or situations. The system may utilize encryption to protect data, and employ a permissions system to display certain data to appropriate people.

### CROSS-REFERENCE TO RELATED APPLICATIONS

This application claims the benefit of U.S. Provisional Patent Application No. 61/973,432 filed Mar. 31, 2014. The text and contents of that provisional patent application are hereby incorporated into this application by reference as if fully set forth herein.

### FIELD OF INVENTION

The subject disclosure generally relates to the field of virtual consciousness. Specifically, embodiments of the present invention relate to systems, devices and methods for utilizing massive data streams to emulate a person's response after the person is no longer able to communicate.

### DISCUSSION OF THE BACKGROUND

One of the greatest fears associated with death is that future generations will be unable to enjoy interacting with the decedent. This is of particular importance to parents. A parent is often so biologically driven to protect the child that the parent is willing to die in order to save the child. The same drive also creates a deep fear that death or disease will render the parent unable to provide guidance for a child. It is no accident that literature is replete with meaningful conversations and attempts to pass on wisdom taking place between a parent on his or her deathbed, and children and grandchildren gathered around. While such conversations, close relationships, and other inter vivos communications may attempt to directly impart wisdom and information, it is not currently possible for a deceased parent to be utilized as a source of information or guidance on a subject that the parent never discussed with a child.

Furthermore, in the event that a person suffers a debilitating disease like Alzheimer's or otherwise suffers from memory loss (e.g., due to head trauma or a brain lesion), or in some other manner has their cognition or ability to perceive data or communicate data compromised, such condition may render the individual unable to make, communicate and/or properly consider decisions for themselves. In other instances the condition may alter the individual's personality, character and/or idiosyncrasies to the point that people that know them well, and even the afflicted individual himself, may no longer consider the individual to be the same person. Furthermore, it may be the case that an individual may be in a vegetative state or minimally conscious after a brain injury. As a result, decisions regarding this individual's life must be made using advance directives, a living will or power of attorney. In such cases, it may be advantageous to have preserved the individual's consciousness prior to injury.

Consequently, there is a strong need for systems, devices and methods that emulate and/or predict a person's response to queries and/or situations after the person is no longer able to communicate for him or herself.

### SUMMARY OF THE INVENTION

The instant invention gathers data through direct measurement, external and other sources throughout a person's remaining life. The system utilizes computer learning techniques to determine, over the course of a person's life, the person's idiosyncrasies, experiences, ethics and morals, attitude, personas, communication preferences, habits, goals, aspirations, beliefs, culture, and other aspects of the person's humanity (the term “consciousness” is used herein to describe this combination of things).

The invention may learn an individual's consciousness by, among other things, recording and analyzing ambient data, sensor data, direct input from a neuronal implant or MRI, media, social media and constant feedback about a user's sentiments about occurrences in everyday life.

Recording and analyzing these components of individuality, the invention is able to create a “virtual consciousness” so as to emulate a person's responses to queries and situations. The accuracy of the emulation may be improved by identifying where its response matches a user's actual response, by allowing a user to identify categories of data or experiences that are atypical (for example, a sarcastic speech at a “roast”), or otherwise. For example, as the system records an interaction that the user has had with another individual, the user may express their sentiments about the encounter with a Boolean (e.g., yes/no, like/dislike, etc.) response. The system may also utilize encryption to protect data and employ a permissions system to display certain data only to appropriate people or in appropriate situations.

In one embodiment, the invention relates to a method of emulating a response of a person, the method comprising (a) gathering data about the person over at least a portion of the person's lifetime, (b) analyzing and/or identifying the data, (c) determining a weighting to give subsets of the data based on the surrounding environment and/or circumstances under which the data was gathered, (d) creating a virtual consciousness of the person based on the data and/or weighting of the data, and (e) predicting the response of the person to queries and/or situations. Future predicted responses may be modified based on the actual response of the person. In addition, monitoring and interpreting the vital signs of the person may aid in the prediction of responses.

In another embodiment, the invention also relates to a system for creating a virtual consciousness of a person, the system comprising, a plurality of devices operably coupled together, wherein (a) at least one of the devices has processing capabilities, (b) at least one of the devices has storage capabilities, (c) each of the devices is configured to gather, analyze, identify and/or store data about the person, and (d) the plurality of the devices are configured to create the virtual consciousness of the person. Commentary from the person may also be used to enhance the experience of other people when they are accessing the virtual consciousness. The virtual consciousness may also be configured to provide the person with forgotten, otherwise inaccessible and/or never observed data. In some embodiments, multiple versions of the virtual consciousness may be stored to monitor and/or measure the person's cognitive and/or mental decline or improvement.

In one aspect, the data stream may be made searchable and video, audio, transcriptions or other representations of actual events and responses to actual events may be made available to searchers. In another aspect, where there is a second user of such a system, such second system may utilize ambient data and/or recent and/or other data to formulate a search for similar data and/or events in the first system. In another aspect, recorded data regarding events may be replayed, whether enhanced or not, utilizing augmented or virtual reality technology.

Embodiments of the present invention advantageously provide systems, devices and methods for gathering, identifying, analyzing, storing and/or utilizing massive data streams to create a virtual consciousness of a person so as to emulate the person's responses to queries from other people and/or situations after the person is no longer able to communicate (e.g., when the person is deceased, lacks cognitive or mental capacity, or when his or her personality has been altered due to decease or defect.)

These and other advantages of the present invention may become readily apparent from the detailed description below.

### BRIEF DESCRIPTION OF THE DRAWINGS

Various non-limiting embodiments are further described with reference to the accompanying drawings in which:

FIG. 1 graphically illustrates a virtual consciousness of a person, according to an embodiment of the present invention.

FIG. 2 schematically illustrates an exemplary method for emulating the response of a person, according to an embodiment of the present invention.

FIG. 3 schematically illustrates a second exemplary method for emulating the response of a person, according to another embodiment of the present invention.

FIG. 4 graphically illustrates a system for creating a virtual consciousness, according to an embodiment of the present invention.

FIG. 5 schematically illustrates a method for permitting access to a virtual consciousness based security measures and preset rules, according to an embodiment of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. These conventions are intended to make this document more easily understood by those practicing or improving on the inventions, and it should be appreciated that the level of detail provided should not be interpreted as an indication as to whether such instances, methods, procedures or components are known in the art, novel, or obvious.

Science fiction writers have long written about the desirability of copying a person's consciousness into a computer. However, up until now, the details about how that may be accomplished in the real world have not been disclosed (or discovered). More recent fiction, such as the “Jor-EI” projection in the Superman® story or the “Zoe” avatar in Caprica™, postulate the creation of a sentient being derived by data-mining of publically available information related to the biological person on which the sentient being is based.

Artificial consciousness that was the target technology for the more recent science fiction examples above is unlikely to be achieved in the near term. It should be understood that while the present invention may interface with an artificial sentience, or serve as partial or full seed data for such a consciousness, the invention does not require such a sentience.

Rather, the instant invention utilizes massive data streams to enable what is effectively a highly accurate prediction of how a person, who is otherwise unable to respond, would respond to a question or situation. The gathering of such data is one aspect of the invention. Another aspect is the analysis of such data, and yet another is the determination of how much weight, if any, to give data points from specific periods of time, given states of inebriation, illness, or consciousness, and/or given audiences, situations, or other factors.

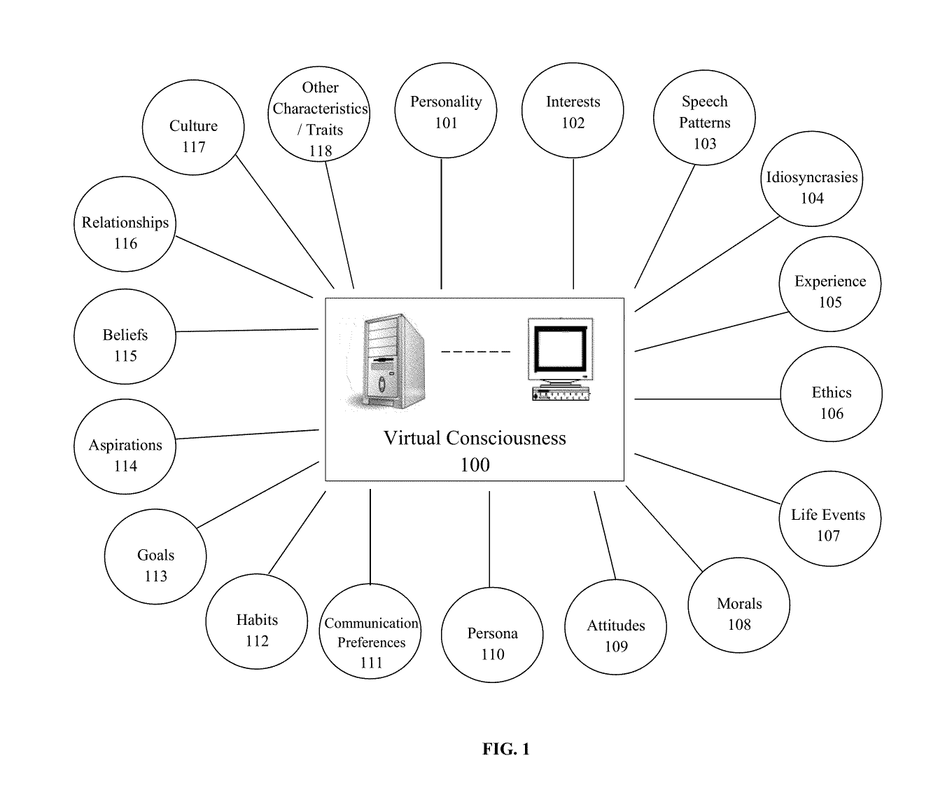

FIG. 1 shows a graphical representation of an exemplary “virtual consciousness” 100, comprising characteristics and traits of a person. Gathering, analyzing, processing and storing data regarding these characteristics and traits make up the virtual consciousness. As shown in FIG. 1, the virtual consciousness 100, may comprise data regarding a person's personality 101, interests 102, speech patterns 103, idiosyncrasies 104, experiences 105, ethics 106, life events 107, morals 108, attitudes 109, persona 110, communication preferences 111, habits 112, goals 113, aspirations 114, beliefs 115, relationships 116, culture 117, as well as other history, characteristics and/or traits 118 (e.g., education, religion, etc.) Once a virtual consciousness is created, it may be used to predict the responses of a person to queries and situations when the person is unable to respond, or unable to respond as he or she has during some relevant time period.

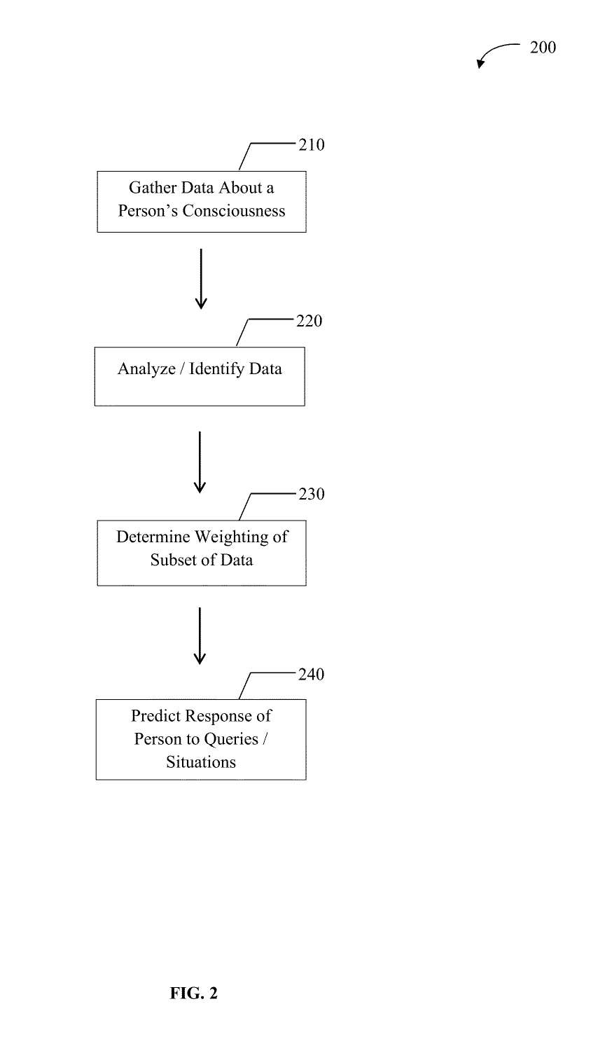

Referring now to FIG. 2, an exemplary method 200 of predicting the response of a person is shown. The method begins at step 210, where data is gathered about a person's consciousness. Such data may be gathered over the entire lifetime of a person, or may be gathered during a subset of the person's lifetime. Data may be gathered from numerous sources and devices, including but not limited to cameras, video recorders, audio recorders, smart phones, laptops, tablets, notepads, personal digital assistants, wearable ubiquitous computing devices (e.g., Google Glass®), near eye wearable displays, see-through wearable displays, medical measurement devices (e.g., devices that measure blood pressure, blood sugar level, alcohol level, enzyme levels, etc.), specialized medical devices (e.g., Scanadu Scout), sensors (e.g., GPS, terrestrial/RDS/satellite radio sensors, temperature, humidity, barometric pressure sensors), biometric sensors (e.g., fingerprint, face recognition, DNA, palm print, iris recognition, retina sensors), analog to digital sensors (e.g., CCS or CMOS camera sensors), social media sites, workplace serves, penal system serves, medical databases (with appropriate permissions), cloud-based servers, home surveillance systems, etc.

At step 220, the gathered data is analyzed and/or identified (e.g., by image, sound, odor, chemical and/or tactile recognition software). In some aspects, computer learning systems (e.g., Bayesian filtering) may be utilized to associate stimuli with certain responses, and in some aspects, audio data is converted to text for analysis.

At step 230, the weighting of subsets of data is determined. For example, less weight may be given to data that was generated when a person was under the influence of alcohol and/or drugs, was in poor health, was tired, was in a poor mood, etc. At step 240, the response of person to queries is predicted.

It is particularly important that the data analysis of step 220 above, not fall victim to what will be described here as the “Stephen Colbert Problem”. If one were to imagine a data stream representing all of Stephen Colbert's experiences, including everything he said or saw, analysis of that data stream by an artificial intelligence (“AI”) or a Bayesian learning algorithm would nearly certainly be faulty. This is because Stephen Colbert is one of the great masters of sarcasm and humorous disingenuous dialogue.

If an implementation of the invention utilizing a Stephen Colbert database were asked “should I vote for the Republican in the upcoming 2040 election?” the invention would be faced with the classic Stephen Colbert problem: “Was he serious?” Indeed, the question may be raised as to which “Stephen Colbert” is being queried—the disingenuous television personality or the truthful, Sunday school-teaching father.

While science fiction descriptions of an artificial sentience based on data mining may be amusing, it is in the implementation of a simulated or “virtual” consciousness where enabling breakthroughs, such as solving the “Stephen Colbert” quandary are made. In one implementation, massive amounts of data are gathered over a portion of a lifetime of a person, and/or in some aspects, previously generated data is utilized. Computer learning systems, such as Bayesian filtering, may be utilized to determine data sets, and stimuli associated with certain responses. The responses of the user and/or third parties may be utilized to determine the mental state associated with the responses.

For example, many common jokes involve an injury to a person. The system may monitor the audio stream, convert the audio to text, and search a database to determine if it is a known joke or a variant on a known joke. The system may also determine whether the reaction of the user and/or third parties is consistent with humor. In so doing, the system may then decline to associate news of an injury, told in the context of a joke, as a response the user would have in learning of an actual injury to a person. Similar distinctions may be made between people the user personally knows and does not personally know; people related to the user and the degree of relation; or other differences.

Revisiting the Stephen Colbert conundrum, a user may be so expert at parody that the system may be unable to determine whether the user is engaged in parody, or the system may not reach the requisite confidence level in such a determination. In such a case, the user and/or a third party may directly provide input to the system, indicating that a certain behavior, response, or behavior taking place in a particular set of situations, time periods, or other conditions is parody. Future predicted responses may then be modified based on the user and/or third party input.

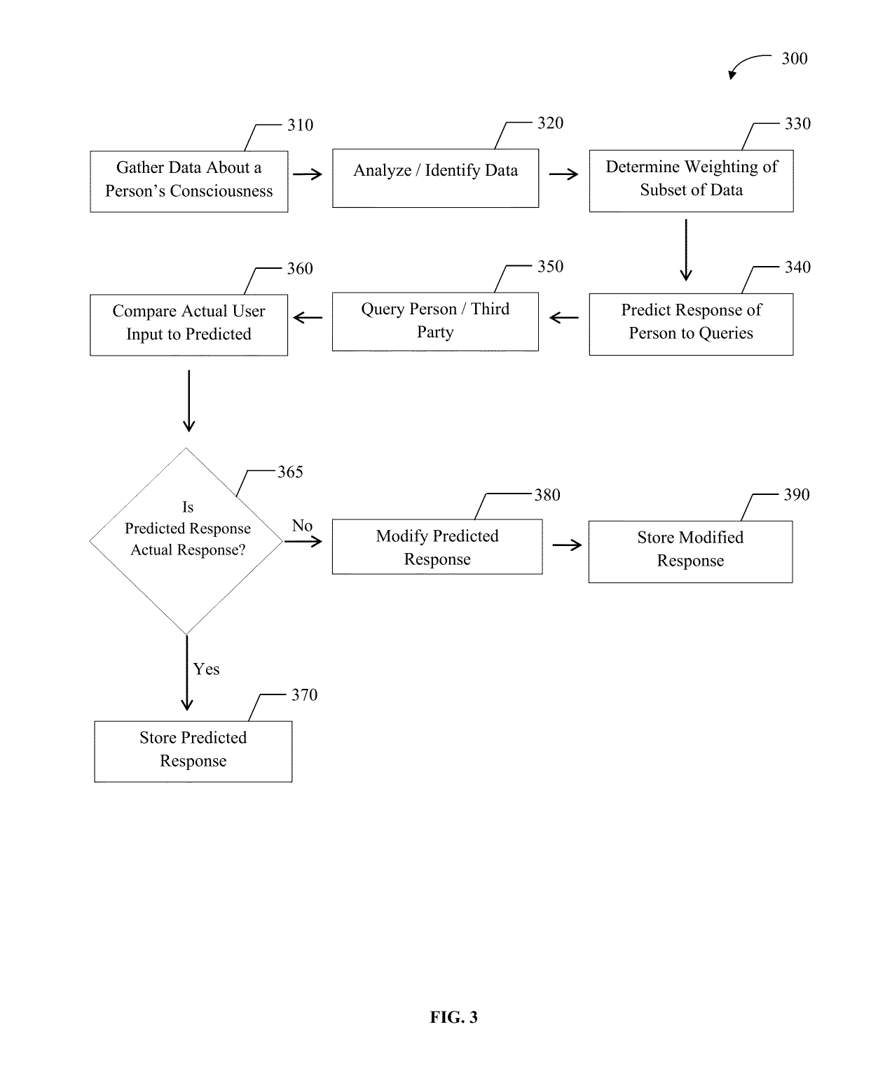

FIG. 3 schematically illustrates an exemplary method 300 for modifying a predicted response based on user input. The steps 310 through 340 of method 300 are similar to the steps 210 through 240 of method 200 of FIG. 2. Method 300 starts at step 310, where data is gathered about a person's consciousness. As with step 210 of FIG. 2, the data may be gathered from the numerous devices described, as well as potentially others. At step 320, the data is analyzed and/or identified, and at step 330, the weighting of subsets of the data gathered is determined. At step 340, the person's response to queries is predicted.

At step 350, the person and/or a third party is prompted to provide input as to how the person would respond and/or behave, or whether the responses and/or behaviors are related to a joke, sarcasm or a parody. At step 360 the predicted response is compared to the user input, and at step 365, it is determined whether the predicted response/behavior matches the actual response/behavior. If the response/behavior matches, the method ends at step 370, where the predicted response/behavior is stored. If the response/behavior does not match, then at step 380 the predicted response/behavior is modified, and at step 390, the modified response is stored.

Similar adjustments may be made for conditions where a response of a user in one setting is divergent from the response in another setting. For example, a user who is drunk may respond differently than a user who is not, and in such a case direct input, measurement of blood alcohol level, or calculation of estimated blood alcohol level based on observed drinks taken over time, slurring of speech or other indicia may be utilized.

In one aspect, data obtained in certain mental conditions or settings (e.g., while hosting the Stephen Colbert show, consuming alcohol, taking mood-altering drugs, etc.) may be ignored. In another aspect, data obtained in certain settings may be given a reduced or increased weighting. For example, a discussion about final arrangements upon death may be given more weight when discussed with a loved one than with a casual friend.

In another aspect, when a response from the virtual consciousness is based on data obtained in a different, questionable, or otherwise less reliable context, the response may be marked and/or tagged as less reliable. On the other hand, if a parody response is desirable, the system may be asked to provide extra weight to information learned in a parody context. Similarly, if a drunk response is desirable (e.g., “dad was a mean drunk, let me show you”), the system may provide a response based only or primarily on data obtained while the user was drunk.

Aspects of the invention involve identifying environmental elements and utilizing that identification to provide additional data. For example, if the system does an audio fingerprint and determines the user is watching Season 1, Episode 1 of The Simpsons®, the system may access a database with a transcript of the episode, access a database with the expected responses of people to portions of the show (e.g., when people who have had a male child may laugh), or otherwise utilize the data to supplement the data directly measured. In some aspects, audio data is converted to text for analysis.

In another aspect, statements and actions by other people may be associated with the person individually (e.g., “Joe”). The relationship of the other person to the user (e.g., “oldest son”), the actions of the other person proximate to the interaction (e.g., “drunk 16 year old oldest son”), the profession of the person (e.g., “doctor”, “teacher”), or other characteristics of the person may be associated with the person. Such interactions may then be utilized to determine likely responses by the virtual consciousness.

In one aspect, the age or mental condition of the virtual consciousness may be adjusted. For example, the virtual consciousness may be calibrated so that it only or primarily utilizes data that would have been accessible by the user at age 40, thereby generating a response similar to that which the user may have given at 40. In another aspect, the virtual consciousness may be calibrated so that it only or primarily utilizes data that was generated when the user had or had not taken a certain medication, the user's vital signs indicated that the user was in good health, the user's tone or actions indicated that they were in a good mood, the user was not tired and/or was not at work, or the user was in some other mental state and/or condition. In such a manner, it is possible to generate a virtual consciousness that is different than the full virtual consciousness that would result from use of the whole data set.

Such partial virtual consciousness may be more desirable for a person or entity interacting with the virtual consciousness. In one example, a user who is told that he is a “mean drunk” may calibrate his virtual consciousness to generate a version of him that is based only on times when he was drunk, and he may then interact with that consciousness to experience personally what his behavior is like when he is drunk.

In one aspect the instant invention may also present as a variety of devices paired, networked and/or otherwise connected in some fashion. For instance a pacemaker, a notebook, a smartphone, a near eye wearable display, and/or an at home surveillance system may all be interconnected such that the instant invention has access to all of the devices' data. The system may gather vital sign data to compare to other recorded events from the pacemaker. The system may pull documents, emails, photos, video, search history and/or other identifying data from the notebook and/or smartphone. This data may inform the system about the user's interests, speech patterns, preferences and/or life events, as well as people in the user's life. The smartphone may furthermore offer the system additional information such as location data from the GPS, purchase data from the NFC chip, and/or movement data from the accelerometer. While this data may not, in some aspects, serve as the primary source from which the system may learn the consciousness of the user, the system may be primed, configured or otherwise calibrated to the idiosyncrasies of the user.

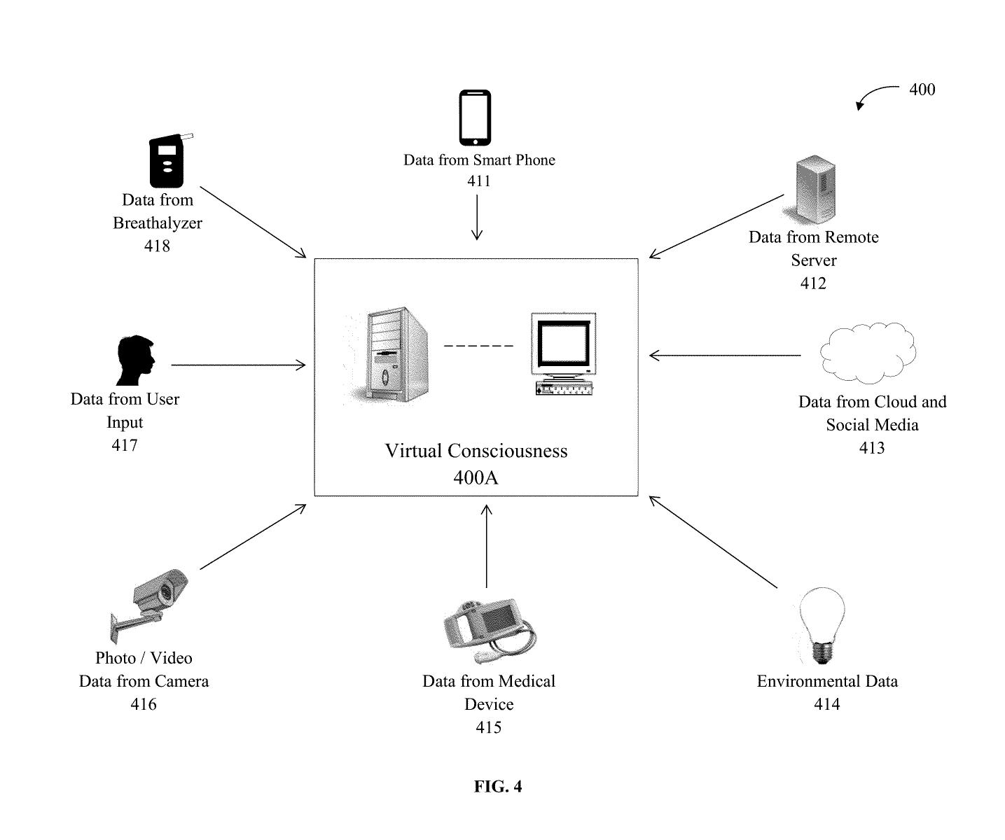

Referring now to FIG. 4, therein is shown a graphical illustration of a system 400 for gathering, analyzing and storing data to create a virtual consciousness 400A. As shown in FIG. 4 and described above, the instant invention may incorporate one or more devices to gather data. For example fingerprint, GPS, cellular voice, cellular, Wi-Fi, Bluetooth, data generated as a result of internet usage, SMS usage, etc., may be gathered from smartphone 411, body temperature, pulse rate, respiratory rate, blood pressure, and/or other vital signs may be gathered from medical device 415. In some instances, the medical device 415 may be a specialized, wearable medical device (e.g., Scandau Scout). Field of vision, ambient sound, voice, motion, location, movement, nearby environmental elements, nearby people and objects, etc., may be gathered by camera 416.

Data may also be gathered from nearby networked devices (e.g., from breathalyzer 418), cloud-based and/or social networking sites 413, remote servers 412 (e.g., workplace servers, penal system servers, etc.), directly from the user 417, or from one or more sensors reading localized environmental data 414. Although the embodiment of FIG. 4 shows these particular data sources, other data sources (e.g., third person direct input, data form a wearable device, etc.) may also be gathered. The data gathered may be stored in raw form for later processing, stored in processed form, or a combination. The storage may be local, remote, a combination, or local until remote storage is accessible, at which point is may be transferred.

Vital sign monitoring may aid the system in making connections between data points or events, indicating how an individual felt at the time that the data point was collected. For example, during an altercation, the system may record audio of the user crying in conjunction with an elevated pulse and respiration rate, and associate these vital sign readings with a displeasing experience. Based on the data gathered, the system may determine that the user has an aversion to confrontation.

In another instance, a user may work in a high stress environment. When the system records the user in an emergency situation such as a code blue in an emergency room, the system may compare the vital signs of the user to other users who utilize the system and determine that the pulse and respiration rate of the user was lower than average comparatively, and thus conclude that the user performs well under such conditions and/or is comparatively unaffected by the particular kind of stress. Such readings may also permit a determination that one situation is analogous to another. For example, if a user indicates that he was very upset during an altercation (whether directly providing that information to the device, by inference, and/or by analysis of statements or other expressions made by the user contemporaneously or later), when the user experiences similar vital signs during another event, the system may score higher the likelihood that the user was very upset during that second event.

An important method by which the system learns a user's consciousness (e.g., how a user thinks) may be by monitoring the user's vital signs, viewing events from the user's perspective, as well as viewing the user as a bystander. Simultaneously, the system may compare the data gathered during the observation of the user's experience, to a histogram of reactions from other (in some cases anonymized) users in a similar experience. This may provide the system with a frame of reference from which to interpret the data gathered from the user.

In some aspects, the system may couple observed and/or compared data to the feedback given directly to the system regarding the recently experienced event similar to a short debrief. The debrief may be recorded by the system, analyzed and then incorporated into the experience data, or may be stored as ancillary data that may later be reviewed in conjunction with the event to further understand the user's personal reflections or after thoughts. The “debriefs” may be input into the system as a result of a prompt for feedback from the system or may be submitted voluntarily as the user sees fit. Additionally, the system may receive or accept text, audio, video, resonance imaging, or other thought-based feedback. The user may furthermore review recording segments and provide voice over or other commentary for viewers of the events to hear while viewing the recording and/or to assist the system in learning the user's consciousness. The commentary may be muted as the viewer sees fit. This amalgamation of the recordings and/or analysis of the user's experiences, reactions to experiences, and afterthoughts may contribute to the user's virtual consciousness.

The instant invention may present as a system that is protected with encryption and permissions. The encryption may be some public key or symmetric character based encryption (such as hexadecimal) with a set length (such as 256-bit). The encryption may also take other forms, and the encryption protocol may be updated for future data received, and/or applied to past data, as encryption technology changes. Permissions may be set by groups or classes of association relative to the user, or as measured by other criteria. For example, it may be set such that nuclear family members have access to certain segments of the virtual consciousness that colleagues for instance, may not. Some segment of the virtual consciousness may not be available to anyone other than the user, and may be referred to as the virtual subconscious. Such data may only be available to authorities such as the police, FBI or CIA in exigent situations, in which, for instance, a subpoena or a warrant is issued, and/or the user is charged of a crime or incarcerated.

Segments of the artificial consciousness may even be hidden away from the user at the users request to decrease the probability of reliving undesirable events. Such events may be tagged by the user and stored in such a way that the user may only be able to access the memory segments if the user answers a series of questions to establish the user's state of mind, or the system gauges the state of the user's physiology through the user's vital signs. In this way the system may perform a virtual polygraph on the user to determine if the user is telling the system the truth, about for instance, his state of mind.

In one aspect, the user and/or others may be presented with recorded data that has been modified in a manner that makes certain events more acceptable, certain lessons more accessible, or for other reasons. While such alteration is useful in the context of the artificial consciousness, it may also be useful even for “life blogging” cameras, video capture devices, or other methods by which users may come into possession of video and/or other data recording an event. For example, a user's memory of a bicycle accident where the user suffered a compound fracture may be highly distressing. As the user accesses the video or still images associated with the accident, the images may be altered to reduce the amount of blood and to hide the otherwise visible edges of bone. In one aspect, such modifications may be made based on measurements of biometric or other feedback obtained from the user while viewing, discussing, or otherwise revisiting those events. The changes may be made incrementally over a series of viewings, so that the associated memories seem sufficiently consonant with the images such that the images are believed to be accurate, and therefore the user allows the images to gradually alter the user's actual memories.

In reality, under normal circumstances the average person may not be able to lie to himself As a result, under normal circumstances the person may also be unable to hide or suppress undesirable memories. The instant invention may be able to allow users to set rules for certain parts of the virtual consciousness or virtual memory in addition to security measures that prevent access or limit access to memories when the system determines that the user is not in a state to handle the memories.

Likewise these same permissions and security measures may be implemented in situations when another person is trying to access the virtual consciousness. For example, if a spouse of the person who is the basis of the virtual conscious (the “owner”) desired to know details about the relationship of the owner and the owner's secretary at the owner's workplace, the system may prompt the requesting spouse with questions. In another aspect, if the requesting spouse was also using a compatible virtual consciousness aggregation system, the two systems may communicate. In this way an emotion based permissions system may be established between compatible systems such that, the owner of the first system may set an emotional parameter that must be met in order for a requester (the second system) to access information.

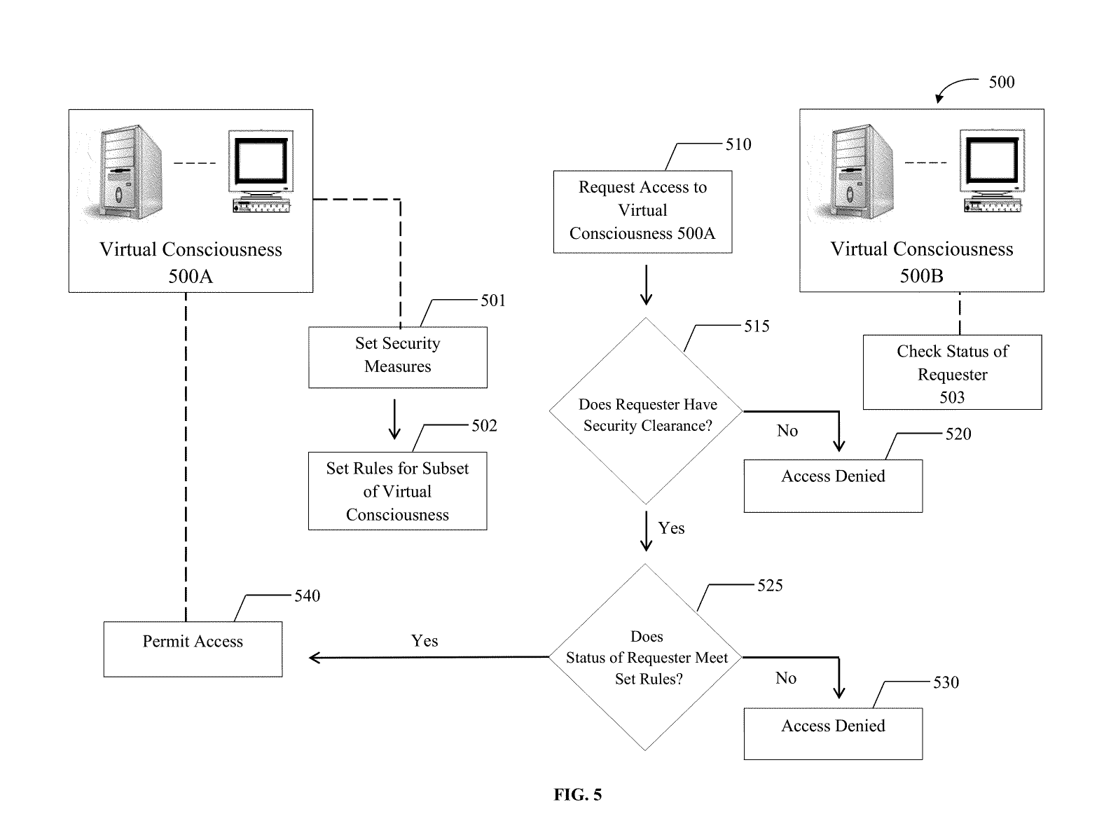

Referring now to FIG. 5, an exemplary embodiment of a method 500 wherein one virtual consciousness is attempting to access information stored in another virtual consciousness is schematically illustrated. In the embodiment of FIG. 5, a second virtual consciousness 500B is attempting to access information in a first virtual consciousness 500A. Prior to, or simultaneously with the attempt to gain such access, the first virtual consciousness 500A, at step 501, sets security measures to prevent unauthorized access. Such security measures may include, but are not limited to, encryption and permissions. The encryption may be a public key or symmetric character based encryption (e.g., hexadecimal) with a set length (e.g., 256-bit). The encryption may also take other forms, and the encryption protocol may be updated for future data received, and/or applied to past data, as encryption technology changes. Permissions may be set by groups or classes of people based on relationships to the user, or as measured by other criteria.

At step 502, the first virtual consciousness 500A sets rules for access to subsets of the virtual consciousness 500A. Such rules may include, but are not limited to, what the level and/or range that certain vital sign data of the requester must fall within in order to be permitted access to specific subsets of virtual consciousness 500A. Such rules may be emotion based, medically based (e.g., whether the requester is under the influence of alcohol and/or drugs), time of day related, etc.

At step 510, the requester asks for permission and, depending on the security measures set by virtual consciousness 500A, may respond to a security prompt. At step 515 a determination is made as to whether the system of the second virtual consciousness 500B has the proper security clearance. If the requester does not have the proper clearance, at step 520, access to virtual consciousness 500A is denied. If the requester does have the proper clearance, then the system of the second virtual consciousness 500B may, at step 503, check the status of the requester (e.g., the requester's emotional and/or medical state, etc.), and inform the system of the first virtual consciousness 500A of the requester's emotional state, heart or respiratory rate, or whatever measures the system of the first virtual consciousness 500A has set as rules. At step 525, a determination is made as to whether the status of the requester meets the rules preset by virtual consciousness 500A. If the status of the requester does not meet the requisite criteria and/or rules, then at step 530, access to virtual consciousness 500A is denied. Only if the owner of system the first virtual consciousness 500A is satisfied with the status of the requester (e.g., the vital signs, physiologic, neurologic or other reading(s)), will the system of the first virtual consciousness 500A, at step 540, permit access.

Taking a grieving widow of the recently deceased owner as an example, based on preset rules and the emotional status of the grieving widow, the system of virtual consciousness 500A may present information to the widow that is consistent with helping the widow through the experience, such as by providing soothing responses. In one aspect, the system of virtual consciousness 500A may respond in a manner consistent with the owner's past responses as influenced by the emotional state of others in general and/or the widow in particular.

In one aspect, this may be accomplished by changing the weighting given to portions of the dataset used to generate the virtual consciousness 500A. For example, a far higher weight may be given to information about the owner's behavior during times when he was comforting a grieving person than when he was playing games.

In one aspect advanced directives may be recorded for certain situations, and may be played back when the appropriate time arises. Furthermore, in the event of an accident or disease that renders the system owner minimally conscious or in a vegetative state, the system may be asked what may be done with the owner, and the system may provide a response based upon, the thoughts, experiences, and events from the owner's life. In one example, if a system's owner fell into a coma post operation (e.g., after a being involved in a car accident), the attending physician may ask the system, what may be done with the owner. The system may refer back to a conversation that the owner and the owner's brother had about DNRs (Do Not Resuscitate directives) while the two were watching an episode of House M.D. ™. During the conversation the owner may have said that he “would elect to use a DNR anytime that there was a chance that [his] quality of life may change for the worse.” The system could then inform the attending physician that the owner would like to be taken off of life support or not be restored in the event of heart failure. Additionally the system may play the recorded scenario for the attending physician to confirm that information relayed to her was true. The system may even inform the attending physician of witnesses that may be contacted to corroborate the information given along with the witness' contact information, based on set permissions.

In one aspect, the virtual consciousness may utilize the responses of others and the interpretations of witnesses and/or those who knew the owner to further refine the accuracy of the response. Returning to the DNR example, consider if the owner's brother stated “we had a running joke—any time we watched House, we both pretended to be just like Dr. House, so anything my brother said while we were watching House, well, that doesn't mean anything.” The system may gauge the veracity of the brother, may review its records to determine if this appears true (for example, by determining whether there is greater than a certain level of divergence between the owner's normal responses and those made while watching House, or otherwise), and may then change the weighting of that exchange, all exchanges observed while watching House, or a subset of those exchanges.

In an instance in which the owner of the virtual consciousness is deceased or has lost portions of his memory due to some disease such as dementia, the virtual consciousness of that owner may serve to advise or inform the owner's progeny. In one example, if the grandson, Aaron, of an owner, Chadwick, asked the son of the owner (Aaron's father, Bartholomew), what Aaron's grandfather, Chadwick, was like when Chadwick was Aaron's age, Bartholomew, may ask the system. The virtual consciousness may recount stories from Chadwick's youth or play recordings from events in Chadwick's life at Aaron's age.

In one aspect the permissions and settings of the system may be configured to change in response to elapsing of time periods, life events, changes in physiology, and/or other changes. For instance, in the event of marriage, the system may be configured to change the permissions granted to the system owner's new spouse. In another example the system may be set to reveal everything to the nuclear family of the owner in the event of the owner's death. As a result, Aaron may be granted full access to his grandfather's life experiences. In another example, the system may utilize the virtual consciousness to determine what the owner thought appropriate to share with a person Aaron's age, and adjust the sharing rules appropriately as Aaron ages.

In another aspect, the system may be able to use the life experiences of the deceased owner to formulate and deliver advice in response to questions posed by the owner's family, friends or other entities (with granted permissions). In one instance Aaron may ask Chadwick's virtual consciousness if he should move into an apartment with his longtime girlfriend. The system may review Chadwick's virtual, real or simulated memories of moving in with roommates (e.g., Chadwick's wife, Chadwick's girlfriend, etc.). The system may analyze the different vital response readings in correlation with visual and audio data that the system has stored of these events.

The system may then determine that these events were exciting and resulted in a healthy amount of stress. The system may then compare one or more of those observations to visual, audio and vital sign data from when Chadwick's roommates caused them to lose a security deposit upon moving out, his wife left after a separation, and his girlfriend left in the middle of the night after a heated altercation. After comparing theses selected events and physiological responses to these events, the system may then incorporate Chadwick's feedback and reflections of the selected events before compiling the final response. The final response may be something like “I had good times living with other people and I learned a great deal, however, in my experience, going separate ways was often difficult and especially taxing when I really cared for the person.”

In one aspect, the system may recount events or relay information in the dialect, tone and/or volume of the owner when the owner was alive or mentally competent, so that the system sounds like the owner and/or expresses the same mannerisms. In another aspect, the system may utilize a composite, artificial, recorded, or other image or video of the owner, optionally at an age different than the age the owner was at time of death, and may cause that image or video to reflect non-verbal communications data, such as facial expressions.

In one aspect, the data stream may be made searchable, and video and/or audio, transcriptions, or other representations of actual events, and responses to actual events, may be made available to searchers. In another aspect, where there is a user of a second such system, such second system may utilize ambient data, recent and/or other data to formulate a search for similar data and/or events in the first system. In another aspect, recorded data regarding events may be replayed, whether enhanced or not, utilizing augmented or virtual reality technology.

In another aspect the system may be able to provide the owner of the system with access to otherwise forgotten, inaccessible, and/or data never gathered by the real consciousness of the owner (“phantom data”). Phantom data may include, among other things, audio, video and other data obtained while the owner was unconscious; video, audio and other data obtained during a period the owner is unable to recall (such as when the user has transient amnesia or during the period when the user experienced infantile amnesia); video, audio and other data that the user may have been present for, but did not observe and/or if observed, has forgotten; and/or other data.

In one aspect, it is possible to monitor brain patterns to determine if a user has a recollection of a thing the user is then observing. Similarly, neuroimaging makes it possible to determine various thoughts of a user. Such data may be utilized to enhance the virtual consciousness. In one aspect, the virtual consciousness may “learn” what an owner believes important enough to remember by determining if a user has had the opportunity to observe something at a first time period, but then has a response when observing the same thing at a second time period that is consistent with the user having no or a limited recollection of previously seeing the thing.

In another aspect, it may be advantageous to display or otherwise make known confidence scores or other measures of how likely the device determines the predicted response to be accurate. In another aspect, multiple possible responses may be provided, optionally in conjunction with probability and/or prediction accuracy data.

In one aspect, it may be advantageous to store multiple versions—either virtual or otherwise—of a virtual consciousness. Such multiple versions may be useful, among other things, to persons suffering from cognitive or mental decline. Such multiple versions may be used, among other things, to monitor progress of the ailment, compare the differences, to monitor the rate of decline or improvement, to identify how much different they are than their former self, how the affliction has affected their consciousness, and/or for other purposes.

What is claimed is:

1. A method for emulating a response of a person, the method comprising:
gathering data about the person over at least a portion of the person's lifetime;
analyzing and/or identifying the data;
determining a weighting to give subsets of the data based on the surrounding environment and/or circumstances under which the data was gathered; and
predicting the response of the person to queries and/or situations based on the data and/or weighting of the data.

2. The method of claim 1, further comprising comparing an actual response of the person to a predicted response, and modifying future predictions based on the actual response.

3. The method of claim 1, further comprising querying the person to identify a subset of the data as atypical, and adjusting the data and/or the weighting given to the subset.

4. The method of claim 1, further comprising utilizing encryption to protect the data, and employing permissions for displaying some or all of the data.

5. The method of claim 1, further comprising, monitoring vital signs of the person, and interpreting the vital signs to aid in predicting the response of the person.

6. The method of claim 1, further comprising giving a reduced weighting or ignoring a subset of data obtained when the person is in a particular physical and/or mental condition.

7. The method of claim 1, further comprising associating relationships and/or actions of other people with the person.

8. The method of claim 1, further comprising modifying a portion of the data related to a specific event based on measurement of biometric feedback obtained from the person while viewing and/or discussing the event.

9. The method of claim 1, further comprising determining the identity of environmental elements and using the identity to gather and/or generate additional data.

10. A method for creating a virtual consciousness of a person, the method comprising:
gathering data about the person over at least a portion of the person's lifetime;
analyzing and/or identifying the data;
determining a weighting to give subsets of the data based on the surrounding environment and/or circumstances under which the data was gathered;
creating a virtual consciousness of the person based on the data and/or weighting of the data; and modifying the virtual consciousness based on one or more characteristic of the person.

11. The method of claim 10, wherein the characteristic(s) are age, physical state, health and/or mental state of the person and/or the task the person is performing.

12. The method of claim 10, further comprising generating a partial virtual consciousness based on a partial data set, wherein the partial data set is based at least one of the one or more characteristics of the person.

13. A system for creating a virtual consciousness of a person, the system comprising,
a plurality of devices operably coupled together;
at least one of the devices having processing capabilities;
at least one of the devices having storage capabilities;
each of the devices configured to gather, analyze, identify and/or store data about the person; and
wherein the plurality of the devices are configured to create the virtual consciousness of the person.

14. The system of claim 13, wherein at least one of the devices is configured to detect and/or measure vital signs of the person.

15. The system of claim 13, wherein at least one of the devices is configured to receive text, audio, video and/or resonance imaging.

16. The system of claim 13, wherein at least one of the devices is configured to receive commentary from the person to be heard by other people when accessing the virtual consciousness.

17. The system of claim 13, wherein the system is protected with encryption and/or permissions.

18. The system of claim 17, wherein the permissions are set based on groups or classes of associations to the person.

19. The system of claim 13, furthered configured to provide the person with forgotten, otherwise inaccessible and/or never observed data.

20. The system of claim 13, further configured to store multiple versions of the virtual consciousness, the multiple versions configured to monitor and/or measure the person's cognitive and/or mental decline or improvement.
